(19) United States
(12) Patent Application Publication
(10) Pub. No.: US 2016/0195076 A1
(43) Pub. Date: Jul. 7, 2016

(54) PROCESS AND UNIT FOR PUMPING FLAMMABLE PRODUCTS CAPABLE OF FORMING AN EXPLOSIVE ATMOSPHERE

(71) Applicant: ORTEC EXPANSION, Aix En Provence (FR)

(72) Inventor: Daniel Rivard, Paris (FR)

(73) Assignee: ORTEC EXPANSION, Aix En Provence (FR)

(21) Appl. No.: 14/911,418

(22) PCT Filed: Jul. 29, 2014
(86) PCT No.: PCT/FR2014/051963

§ 371 Date: Feb. 10, 2016

(30) Foreign Application Priority Data
Aug. 14, 2013 (FR) 1358002

(51) Int. Cl. F04B 15/02; B01D 19/00; F04B 23/02

(52) U.S. Cl. CPC F04B 15/02; F04B 23/02; B01D 19/0057

(57) ABSTRACT

The invention relates to a unit for pumping flammable products capable of forming an explosive atmosphere from a pumping zone to a storage chamber, comprising: a separator for separating said products into a liquid/pasty phase and a gas phase, a positive displacement pump for returning non-gaseous products to said storage chamber, means for placing the separator under vacuum, and a circuit for discharging the gases produced by said unit to at least one demarcated discharge zone. The invention also relates to a corresponding pumping process.

### 1. TECHNICAL FIELD OF THE INVENTION

The invention relates to a method and a unit for pumping flammable liquid or pasty products. In particular, the invention relates to a method and a unit for pumping hydrocarbons, acids, bases, sewage sludge, bio-sludge, primary sludge and, in general, all similar flammable products which can produce an explosive atmosphere (more commonly known by the acronym ATEX). The invention relates in particular to movable pumping units such as hydrotreating lorries intended for draining ATEX sludge storage regions.

### 2. TECHNOLOGICAL BACKGROUND

Throughout the text, the term “flammable product” is used equally to denote hydrocarbons, acids, bases, sewage sludge, bio-sludge, primary sludge and, in general, all similar flammable products which can produce an explosive atmosphere. These flammable products may also be toxic.

An “explosive atmosphere” is a mixture with air, under atmospheric conditions, of flammable substances in the form of gases, vapours, mists or dust in which, following ignition, combustion spreads to the entire unburnt mixture. In other words, an “explosive atmosphere” is an atmosphere which can become explosive due to specific local conditions.

A great many industries, such as the chemical industry, petrochemical industry, food-processing industry, metallurgy industry, etc., produce sludge which can produce explosive atmospheres. It is therefore necessary to regularly pump this sludge in order to be able to transport it to specialised treatment and/or storage sites. Pumping operations of this kind are also necessary in order to purge industrial drains in order to recover waste produced by high-pressure cleaning of industrial facilities, in order to extract sludge from water purification plants, in order to dry out the bottoms of vessels to allow them to be inspected or maintained, etc.

These pumping operations entail many risks to the safety and health of the staff, which risks are related to the explosive nature of the pumped products and to the emission of harmful gases such as volatile organic compounds (more commonly known by the acronym VOC). Moreover, the manufacturer is not always well versed in the exact composition of the pumped products.

There are currently three pumping techniques for products of this kind: vacuum pumping, aeraulic pumping and pumping by means of transfer pumps.

Vacuum pumping consists in using a vacuum pump to drain the vessel containing the products to be pumped without introducing air. A storage chamber is arranged between the pump and a suction pipe which is permanently immersed in the product to be pumped. This technique has the advantages of making it possible to stop the vacuum pump from running during the pumping operation, while maintaining a suction capacity as long as the differential with respect to atmospheric pressure is present. Moreover, this technique allows the pump to be installed a long way from the product to be pumped, on account of the suction force. Said technique also makes it possible to prevent the product from coming into contact with the pump, with the exception of vapours or gases, and to limit the amount of pollutants discharged. However, this pumping technique has the disadvantages, in particular, of promoting boiling of the volatile products and desorption of the gases, and of increasing the risks of explosion and emission of harmful gases such as volatile organic compounds.

Aeraulic pumping consists in using a vacuum pump to drain the vessel containing the products to be pumped, but while introducing air. The addition of air may be deliberate, in order to promote transport of the product and to increase the pumping efficiency, or it may be inadvertent when the pipe is no longer sufficiently immersed in the product when pumping has finished. This technique requires the pump to run permanently and has the advantages of it being possible to install the pump a very long way from the product to be pumped on account of the suction force, of it being possible to pump liquid products comprising solid foreign bodies (which is impossible using a volumetric pump), and of it being possible to pump layered products. This technique also prevents the product from coming into contact with the pump, with the exception of vapours or gases. However, said technique has, in addition to the disadvantages of the vacuum pumping method, the disadvantage of discharging very significant volumes of gas into the atmosphere (high pumping rate and no possibility of stopping the pump during the pumping operation), and therefore emits more pollutants through the vent of the vacuum pump, thus further promoting the risks of explosion.

Transfer pumping consists in using a volumetric pump which directly suctions the products. This technique has the advantages of it being possible to pump very volatile products, of limiting the discharge of pollutants, and of pumping viscous and pasty products. However, this technique, although being the technique having the fewest risks, has now been abandoned as it is not compatible with high pumping rates and does not make it possible to completely drain the vessels. The limited suction force of this type of pump makes it necessary to position said pump close to the tank to be drained.

There is therefore a need to have access to a new pumping technique which makes it possible to make the pumping operations safe, but while at the same time making possible rapid pumping and complete drainage of the vessels.

### 3. OBJECTS OF THE INVENTION

The invention aims to remedy at least some of the disadvantages of the known pumping devices and methods.

In particular, the invention aims to provide, in at least one embodiment of the invention, a pumping device and method which make it possible to limit the dangerousness and the toxicity of a pumping operation for flammable products which can form an explosive atmosphere, while also maintaining high pumping rates.

The invention also aims to provide, in at least one embodiment, a pumping device and method which make it possible to limit the time for which the pumped products are exposed to the vacuum, so as to limit the desorption of gases dissolved in the products.

The invention also aims to provide, in at least one embodiment of the invention, a pumping device and method which make it possible to reduce the amount of air admitted into the pumping circuit.

The invention also aims to provide, in at least one embodiment of the invention, a pumping device and method which make it possible to reduce the surface area exposed to the vacuum.

The invention also aims to provide, in at least one embodiment of the invention, a pumping device and method which make it possible to limit the discharge of harmful gases.

The invention also aims to provide, in at least one embodiment of the invention, a pumping device and method which make it possible to confine the dangerous region to the pumping region.

### 4. DISCLOSURE OF THE INVENTION

In order to achieve this, the invention relates to a unit for pumping flammable products, which can form an explosive atmosphere, from a pumping region to a storage chamber, characterised in that it comprises:
a separator for separating said products into a liquid/pasty phase and a gaseous phase, comprising a cyclonic vessel, a product inlet mouth, a delivery outlet for non-gaseous products, and a suction opening, said separator being suitable for being arranged in said pumping region,
a volumetric pump for delivering non-gaseous products to said storage chamber, said pump being connected to said product delivery outlet of said product separator,
means for evacuating said cyclonic vessel of said product separator, which means are suitable for ensuring suction of the products from said pumping region to said separator without evacuating said storage chamber,
a circuit for discharging gases produced by said unit to at least one marked discharge region.

A unit according to the invention thus makes it possible to limit desorption of the pumped products by using two circuits: a short vacuum suction circuit, and a pressurised circuit for delivering non-gaseous products. In particular, the product separator is arranged directly in the pumping region and the vacuum suction circuit is intended only for suctioning products from the pumping region to the cyclonic vessel of the separator. The term “pumping region” denotes the vessel which contains the products to be pumped and a specific region which surrounds said vessel. This region is defined by the various legislation regarding pumping of ATEX products. In other words, it is a geographic region which contains and surrounds the products to be pumped. It is therefore not limited purely to the vessel containing the products to be pumped, but also to the immediate vicinity thereof.

Delivery of products from the separator to the storage region is achieved by using a pressurised circuit comprising a volumetric pump. This product transfer is therefore not obtained by using a vacuum circuit, which limits the time for which the products are exposed to the vacuum, and thus desorption of gases, and thus the risks of toxicity and explosion. Moreover, the chamber for storing the flammable products is not evacuated, which very significantly limits desorption throughout the entire duration of the pumping operation, and thus the emissions of harmful and explosive gases. The risks of explosion are greatly reduced. A pumping unit according to the invention thus makes it possible to significantly limit the dangerousness of the pumping operation, while maintaining a good pumping rate and a capacity which ensures complete drainage of the container to be cleaned.

Moreover, since the vacuum circuit is short, the amount of air, which acts as an oxidant, admitted to the vacuum circuit in order to ensure the transfer of flammable products from the pumping region to the storage chamber, is reduced. This also contributes to limiting the dangerousness of the pumping operation.

Advantageously and according to a first variant of the invention, said means for evacuating said separator comprise a vacuum pump which is arranged outside said pumping region and the storage chamber and is connected to said suction opening of said separator.

According to this variant of the invention, the vacuum required for ensuring the transfer of flammable products from the pumping region to the vessel of the separator is achieved by using a vacuum pump which is installed outside both the pumping region and the storage chamber.

In the case where the pumping unit according to the invention is installed on a hydrotreating lorry, the vacuum pump of the hydrotreating lorry can act as the vacuum pump of the invention.

This vacuum pump is arranged such that the storage chamber is not on the vacuum circuit upstream of the vacuum pump, so that the chamber can be at atmospheric pressure.

Advantageously and according to this variant of the invention, said gas discharge circuit comprises a channel for discharging gases produced by said separator, which channel is connected to said suction opening of said separator, said vacuum pump being arranged on this channel such that this channel contributes both to evacuating said cyclonic vessel and to transferring the gases produced by the separator to a marked discharge region.

The gas discharge circuit ensures that the gases produced by said unit are discharged to at least one marked discharge region.

According to an advantageous variant, the gas discharge circuit also comprises a safety valve which is arranged in the storage chamber and is kept in the open position in order to protect the chamber from risks of excess pressure by keeping it at atmospheric pressure.

In combination, the gas discharge circuit comprises a channel for discharging gases resulting from desorption of products in the storage chamber, which channel is arranged between the safety valve and a marked discharge region.

Advantageously and according to a second variant of the invention, said means for evacuating said product separator comprise a hydro injector which is mounted on said suction opening of said separator and is supplied with high-pressure water from a water store.

According to this second variant, the vacuum is created in the cyclonic vessel of the separator by using a hydro injector which is supplied with high-pressure water from a water supply. This hydro injector, which is supplied with high-pressure water, makes it possible to create a Venturi effect, causing products to be suctioned from the pumping region to the cyclonic vessel of the separator.

A pumping unit according to this second variant is particularly beneficial since it does not require the use of a vacuum pump. Only a high-pressure water pump is required for ensuring pumping of flammable products.

Moreover, according to this second variant, the dangerous region is confined exclusively to the pumping region which has already been classified an ATEX region.

In the case where the pumping unit according to this second variant of the invention is installed on a hydrotreating lorry, the lorry's high-pressure water store can act as the water store for the hydro injector of the unit according to the invention, and the lorry's high-pressure pump makes it possible to supply the hydro injector with high-pressure water.

Advantageously, a pumping unit according to this variant comprises a hydrocyclone capable of degassing the high-pressure water coming from said hydro injector.

The hydrocyclone makes it possible to separate the gases from the water coming from the hydro injector. In other words, according to this variant, the flammable products are separated into a pasty/liquid phase and a gaseous phase at the flammable product separator, the gaseous phase then being absorbed by the high-pressure water of the hydro injector. The water is then itself separated into a liquid phase and a gaseous phase at the hydrocyclone. This gaseous phase obtained by the hydrocyclone is substantially identical to the gaseous phase which comes from the separator and is transported by the high-pressure water.

Advantageously, a pumping unit according to this variant comprises a volumetric pump for delivering degassed water to said water store.

According to this variant, the unit comprises two volumetric pumps, a pump for delivering the pasty/liquid phase of the pumped products to the outlet of the separator, and a pump for delivering the water degassed by the hydrocyclone.

Advantageously and according to this variant of the invention, said gas discharge circuit comprises a channel for discharging gases produced by said hydrocyclone to a marked discharge region.

The gas discharge circuit ensures that the gases produced by said unit are discharged to at least one marked discharge region.

According to an advantageous variant, the gas discharge circuit also comprises a safety valve which is arranged in the storage chamber and is kept in the open position in order to protect the chamber from risks of excess pressure by keeping it at atmospheric pressure.

In combination, the gas discharge circuit comprises a channel for discharging gases resulting from desorption of products in the storage chamber, which channel is arranged between the safety valve and a marked discharge region.

The channel for discharging gases produced by said hydrocyclone has an outlet which is located on the marked discharge region of the vessel to be drained. The storage chamber emits only an insignificant discharge of gas into the atmosphere.

Advantageously and according to the invention, said storage chamber is arranged at a distance of between 50 and 100 metres from the pumping region.

A pumping unit according to the invention makes it possible to pump a flammable product over a large distance, of around 50 to 100 metres. In the case of using a hydrotreating lorry, the operator can thus install the pumping unit, in particular the separator, in the pumping region and can return to the hydrotreating lorry which carries the storage chamber. Thus the equipment, which is located at over 50 metres from the dangerous region, does not constitute a new ATEX region. The risks of an accident are reduced, in particular by reducing the distance of the vacuum circuit, and the safety for the operators is improved by allowing said operators to control the pumping while being a large distance from the pumping region.

Advantageously and according to the invention, said volumetric pump for delivering products is a pneumatic pump which is activated by means of compressed air.

According to another variant, this volumetric pump can be a pump activated by hydraulic energy.

Advantageously, a pumping unit according to the invention is carried by a hydrotreating combine.

The invention also relates to a method for pumping flammable products, which can produce an explosive atmosphere, from a pumping region to a storage chamber, characterised in that it comprises the steps consisting in:
separating the products directly in said pumping region, by means of a separator for separating products into a liquid/pasty phase and a gaseous phase,
evacuating said product separator in order to ensure suction of the products from said pumping region to said separator without evacuating the storage chamber,
delivering the non-gaseous products from the separator to said storage chamber by means of a volumetric delivery pump,
conveying the gases produced to a marked discharge region.

The method according to the invention is advantageously implemented by a pumping unit according to the invention, and a pumping unit according to the invention advantageously implements a method according to the invention.

Advantageously and according to a first variant of the invention, the step of evacuating the separator consists in connecting a vacuum pump to the separator, said pump being arranged outside the pumping region and the storage chamber.

Advantageously and according to a second variant of the invention, the step of evacuating said separator consists in injecting high-pressure water from a water store into a hydro injector mounted on said separator.

Advantageously, a method according to this second variant comprises a step of supplying a hydrocyclone with degassed high-pressure water, and a step of delivering said water to a water store.

The invention also relates to a pumping unit and a pumping method, characterised in combination by all or some of the features mentioned above or below.

### 5. LIST OF FIGURES

Other aims, features and advantages of the invention will become apparent from reading the following description, which is given purely by way of non-limiting example and which makes reference to the accompanying figures, in which:

FIG. 1 is a schematic view of a pumping unit known from the prior art,

FIG. 2 is a schematic view of a pumping unit according to a first embodiment of the invention,

FIG. 3 is a schematic view of a pumping unit according to a second embodiment of the invention,

FIG. 4 is a schematic view of a pumping unit according to an embodiment of the invention which is mounted on a hydrotreating lorry,

FIG. 5 is a perspective schematic view of a flammable product separator of a pumping unit according to an embodiment of the invention,

FIG. 6 is a schematic view of a pumping method according to an embodiment of the invention.

### 6. DETAILED DESCRIPTION OF EMBODIMENTS OF THE INVENTION

In the figures, scale and proportions are not strictly adhered to for the purpose of illustration and clarity.

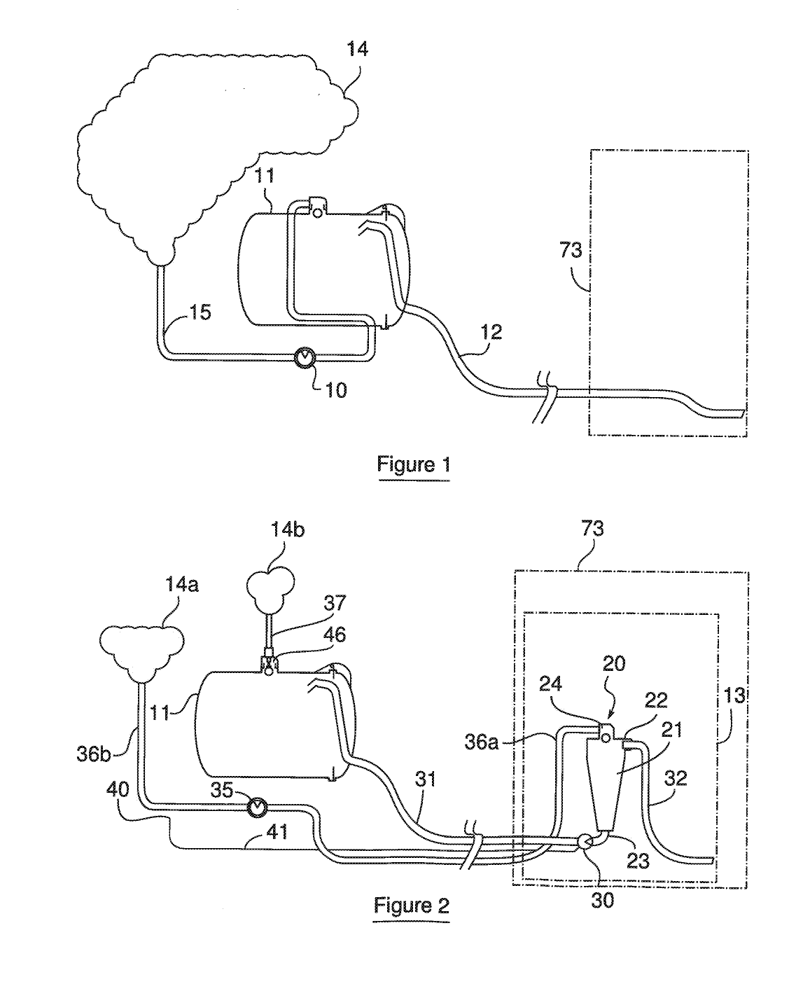

For pumping sludge, hydrocarbons, acids and, in general, all flammable products which can form an explosive atmosphere, it is known to use a pumping unit of the kind shown in FIG. 1. This pumping unit comprises a vacuum pump 10 intended to create a vacuum in a storage chamber 11. This storage chamber 11 is connected to a pumping region 73 via a channel 12 for transferring pumped products. Suction of the flammable products thus occurs by means of evacuating the storage chamber 11, and the gases resulting from desorption of the products are discharged to a marked discharge region 14 arranged at the end of a gas discharge channel 15, which channel is itself arranged between said discharge region 14 and the storage chamber 11. This region 14 for discharging harmful gases into the air is consistent for a pumping unit of the prior art.

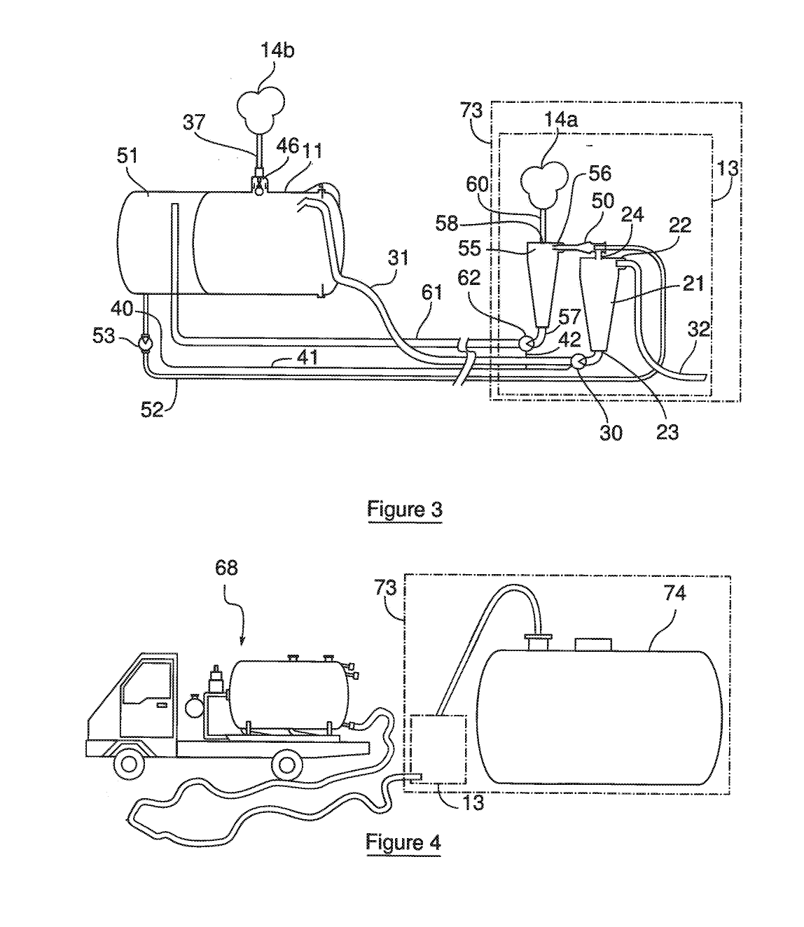

According to the invention, and as shown in FIGS. 2 and 3, the unit for pumping flammable products, which can form an explosive atmosphere, from a pumping region 73 to a storage chamber 11 comprises a separator 20 for separating the products into a liquid/pasty phase and a gaseous phase.

The pumping region 73 comprises an assembly 13 which is described in the following, and a vessel of products to be pumped, which is not shown in FIGS. 2 and 3 for reasons of clarity. FIG. 4 shows the vessel 74 containing the products to be pumped, and the assembly 13, which form the pumping region 73.

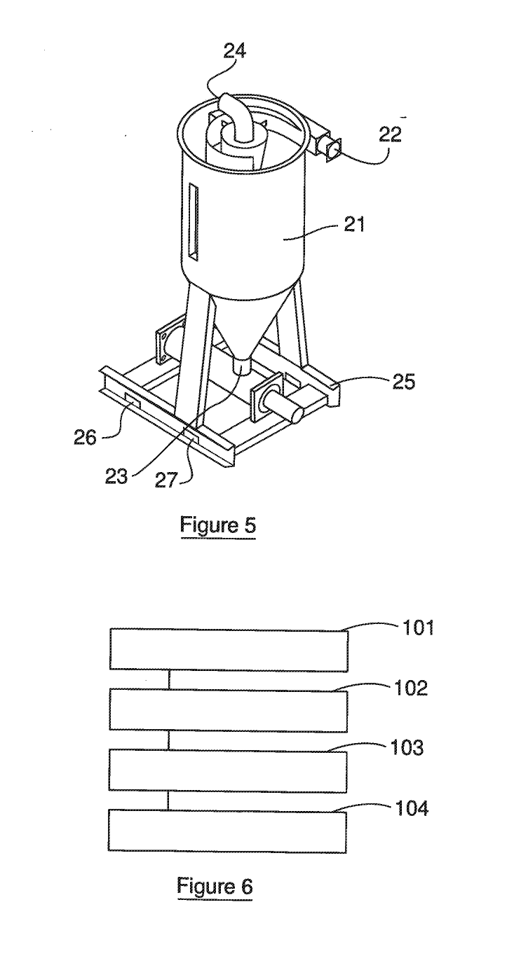

The product separator 20 comprises a cyclonic vessel 21, a product inlet mouth 22, a delivery outlet 23 for non-gaseous products, and a suction opening 24. FIG. 5 shows an embodiment of this product separator 20.

According to an advantageous embodiment, the cyclonic vessel 21 has a reduced capacity, of approximately 200 to 300 litres. This makes it possible to use a separator having reduced dimensions and weight which are compatible with a control operation by an operator. Moreover, this contributes to making possible a good suction rate while limiting the risks of explosion. The separator is suitable, for example, for being mounted on a pallet (more commonly known as a “skid”). The separator according to the embodiment of FIG. 5 comprises a base 25 which forms a handling pallet. This base 25 has openings 26, 27 which are suitable for allowing forks of a fork-lift truck to pass through. A separator of this kind is thus easily controllable by an operator and can be arranged directly in the pumping region, close to the vessel containing the products to be pumped.

The pumping unit according to the invention further comprises a volumetric pump 30 for delivering non-gaseous products, separated by the separator 20, to the storage chamber 11. This volumetric pump 30 is connected to the product delivery outlet 23 of the separator 20. A channel 31 connects the volumetric pump 30 to the storage chamber 11. This channel is for example a strong flexible pipe. According to an advantageous embodiment, and as shown in the figures, this volumetric pump 30 is a pneumatically or hydraulically driven pump. Thus, a source 40 of compressed air or of pressurised hydraulic oil supplies the volumetric pump 30 via a channel 41.

The pumping unit according to the invention further comprise means for evacuating the cyclonic vessel 21 of the product separator 20, which means are suitable for ensuring suction of the products from the pumping region 73 to the vessel 21 of the separator 20.

According to a first embodiment, and as shown in FIG. 2, the means for evacuating the separator 20 comprises a vacuum pump 35. This pump 35 is connected to the suction opening 24 of the separator 20. This vacuum pump 35 can be of any known kind. Said pump is arranged outside the pumping region 73 and the storage chamber 11. In the case where the pumping unit is mounted on a hydrotreating lorry, the lorry's vacuum pump can act as the vacuum pump 35 of the pumping unit.

A channel 36a connects the suction opening 24 of the vacuum pump 35, and a channel 36b connects the vacuum pump 35 to a marked discharge region 14a. Thus, when the vacuum pump 35 is activated, the vacuum is formed inside the cyclonic vessel 21, which brings about suction of products from the pumping region to the cyclonic vessel 21 via a pipe 32 arranged between the product inlet mouth 22 in the separator 20 and the pumping region 73. The products are separated by the separator 20 into a liquid/pasty phase and a gaseous phase. The gaseous phase of the products is suctioned, under the effect of the vacuum pump 35, to the marked discharge region 14a by means of the channels 36a and 36b. The amount of gases discharged in this region 14a is certainly less significant than that discharged by a pumping unit of the prior art. The liquid/pasty phase is delivered, under the effect of the volumetric pump 30 described above, to the storage chamber 11.

A channel 37 further connects the storage chamber 11 to the marked discharge region 14b. This channel makes it possible to discharge the gases which are present in the storage chamber 11 and which result from desorption of the products in this chamber 11. The gases are discharged via a safety valve 46 arranged on the upper wall of the storage chamber 11. This valve 46 is kept in the open position in order to protect the storage chamber 11 from risks of excess pressure in the chamber by keeping the chamber at atmospheric pressure. According to another embodiment, the gases are discharged directly via the safety valve 46, without the channel 37.

The amount of gas discharged into the region 14b by a unit according to this embodiment is certainly less significant than that discharged by a pumping unit of the prior art.

According to the embodiment of FIG. 2, the channels 36a, 36b and 37 form the gas discharge circuit of the pumping unit.

According to a second embodiment, and as shown in FIG. 3, the means for evacuating the separator 20 comprise a hydro injector 50 which is mounted on the suction opening 24 of the separator 20. The hydro injector 50 is supplied with high-pressure water from a water store 51 via a pipe 52 which connects the water store 51 to the hydro injector 50. A water pump 53 is mounted on the pipe 52 in order to pump water from the water store 51 and to convey said water, at high pressure, to the hydro injector. The high-pressure water injected into the hydro injector makes it possible to produce a Venturi effect, which leads to suction of products from the pumping region 73 to the cyclonic vessel 21 of the separator 20. The principle of delivering the liquid/pasty phase of the products separated by the separator 20 to the storage chamber 11 is identical to that described in connection with the first embodiment of FIG. 2. It is therefore not described again for FIG. 3.

According to the embodiment of FIG. 3, the outlet of the hydro injector 50 opens into a hydrocyclone 55 which is capable of degassing the high-pressure water. This water at least in part contains the gaseous phase of the products separated by the separator 20. The hydrocyclone 55 comprises a high-pressure water inlet mouth 56 which is coupled to the outlet of the hydro injector, an outlet 57 for delivering water to the water store 51, and a vapour emission opening 58.

The vapour emission opening 58 is connected to the marked discharge region 14a via a channel 60. This gas discharge thus occurs directly in the pumping region 73. This embodiment is therefore particularly safe, since most of the harmful gas discharge takes place directly in the ATEX pumping region.

The water delivery outlet 57 is connected to the water store via a channel 61 and a volumetric pump 62 arranged on this channel 61. Thus, the water degassed by the hydrocyclone 55 is delivered to the water store 51.

According to an advantageous embodiment, and as shown in FIG. 3, the volumetric pump 62 for delivering water to the water store 51 is a pneumatic pump. Thus, the source 40 of compressed air which supplies the volumetric pump 30 also supplies the volumetric pump 62 via the air channel 41 and a secondary air channel 42 which diverges from the air channel 41 to the volumetric pump 62. According to other embodiments, an air source can be provided for each volumetric pump and/or separate channels can be used in order to make it possible to activate the various volumetric pumps. According to another embodiment, the pump 62 is a diaphragm pump.

In the same way as has been described in connection to FIG. 2, in the embodiment of FIG. 3, a channel 37 connects the storage chamber 11 to the marked discharge region 14b and makes it possible to discharge the gases which are present in the storage chamber 11 and which result from desorption of the products in this chamber 11. According to another embodiment, the gases are discharged directly via the safety valve 46, without the channel 37.

According to the embodiment of FIG. 3, the channel 60 forms the point at which the gas is discharged from the pumping unit. Said point is located in the ATEX region of the vessel to be drained. The channel 37 represents the collection vessel being brought to atmospheric pressure.

FIG. 4 is a schematic view of a hydrotreating lorry 68 using a pumping unit according to the invention. A lorry of this kind is also referred to by the term “combine”. A hydrotreating lorry 68 of this kind is intended for pumping sludge, hydrocarbons or all kinds of flammable products which can form an explosive atmosphere and which are contained in a vessel 74. The pumping region 73 comprises the vessel 74 and the immediate vicinity of this vessel 74. The assembly 13 arranged in the vicinity of the vessel 74, in the pumping region 73, comprises the separator 20 and means for evacuating this separator. It is therefore the assembly 13 according to the first embodiment of the invention as shown in FIG. 2, or the assembly 13 according to the second embodiment as shown in FIG. 3.

Currently, hydrotreating lorries exist which are intended to pump flammable products by means of evacuating the storage chamber 11. A lorry of this kind generally comprises a vacuum pump, a water store, and means for providing high-pressure air. A lorry of this kind can thus usefully contribute to implementing the invention. In particular, in order to implement the embodiment of FIG. 2, in which the means of evacuating the cyclonic vessel of the separator comprise a vacuum pump, the lorry's pump can act as the vacuum pump of the pumping unit according to the invention. In order to implement the embodiment of FIG. 3, in which the means for evacuating the cyclonic vessel of the separator comprise a hydro injector, the water store acts as the water store for injecting high-pressure water into the injector. In this embodiment, the lorry's vacuum pump is unused.

In addition, a lorry of the prior art generally comprises a “high vessel level” safety valve which is intended for protecting the lorry's vacuum pump. This valve can usefully act as the valve 46 which is locked in the open position in order to protect the vessel from excess pressures.

The invention also relates to a method for pumping flammable products, which can form an explosive atmosphere, from a pumping region to a storage chamber.

FIG. 6 is a schematic view of the various steps which the invention comprises.

The first step 101 consists in separating the products directly in the pumping region by using a separator 20 for separating products into a liquid/pasty phase and a gaseous phase. This first step is advantageously implemented by a separator 20 of a pumping unit according to the invention.

The second step 102 consists in evacuating the product separator 20 in order to ensure suction of the products from the pumping region 13 to the separator 20. This second step is advantageously implemented by a pumping unit according to one of the embodiments of FIG. 2 or FIG. 3.

The third step 103 consists in delivering the non-gaseous products from the separator 20 to the storage chamber 11 via a volumetric delivery pump 30. This third step is advantageously implemented by a pumping unit according to one of the embodiments of FIG. 2 or FIG. 3.

The fourth step 104 consists in conveying the gases produced to a marked discharge region 14a, 14b. This fourth step is advantageously implemented by a discharge circuit of a pumping unit according to one of the embodiments of FIG. 2 or FIG. 3.

The invention is not limited to only the embodiments described. In particular, other architectures of vacuum suction circuits and of pressure circuits are possible without departing from the principle on which the invention is based, namely that of no longer directly evacuating the storage chamber.

1. Unit for pumping flammable products, which can form an explosive atmosphere, from a pumping region to a storage chamber,
comprising:
a separator for separating said products into a liquid/pasty phase and a gaseous phase, comprising a cyclonic vessel, a product inlet mouth, a delivery outlet for non-gaseous products, and a suction opening, said separator being suitable for being arranged in said pumping region,
a volumetric pump for delivering non-gaseous products to said storage chamber, said pump being connected to said product delivery outlet of said product separator,
means for evacuating said cyclonic vessel of said product separator, which means are suitable for ensuring suction of the products from said pumping region to said separator without evacuating said storage chamber, and
a circuit for discharging gases produced by said unit to at least one marked discharge region.

2. Unit according to claim 1, wherein said means for evacuating said separator comprise a vacuum pump which is arranged outside said pumping region and the storage chamber and is connected to said suction opening of said separator.

3. Unit according to claim 2, wherein said gas discharge circuit comprises a channel for discharging gases produced by said separator, which channel is connected to said suction opening of said separator, said vacuum pump being arranged on this channel such that this channel contributes both to evacuating said cyclonic vessel and to transferring the gases produced by the separator to a marked discharge region.

4. Unit according to claim 1, wherein said means for evacuating said product separator comprise a hydro injector which is mounted on said suction opening of said separator and is supplied with high-pressure water from a water store.

5. Unit according to claim 4, comprising a hydrocyclone capable of degassing the high-pressure water coming from said hydro injector.

6. Unit according to claim 5, comprising a volumetric pump for delivering degassed water to said water store.

7. Unit according to claim 5, wherein said gas discharge circuit comprises a channel for discharging gases produced by said hydrocyclone to a marked discharge region.

8. Unit according to claim 1, comprising a safety valve which is arranged in said storage chamber and is kept in the open position in order to protect the chamber from risks of excess pressure.

9. Unit according to claim 1, wherein said storage chamber is arranged at a distance of between 50 and 100 metres from the pumping region.

10. Unit according to claim 1, wherein it is carried by a hydrotreating combine.

11. Method for pumping flammable products, which can produce an explosive atmosphere, from a pumping region to a storage chamber,
comprising the steps of:
separating the products directly in said pumping region, by means of a separator for separating products into a liquid/pasty phase and a gaseous phase,
evacuating said product separator in order to ensure suction of the products from said pumping region to said separator without evacuating said storage chamber,
delivering the non-gaseous products from the separator to said storage chamber by means of a volumetric delivery pump, and
conveying the gases produced to a marked discharge region.

12. Pumping method according to claim 11, wherein step of evacuating the separator consists in connecting a vacuum pump to the separator, said pump being arranged outside the pumping region and the storage chamber.

13. Pumping method according to claim 11, wherein step of evacuating said separator consists in injecting high-pressure water from a water store into a hydro injector mounted on said separator.

14. Pumping method according to claim 13, comprising a step of supplying a hydrocyclone with degassed high-pressure water, and a step of delivering said water to said water store.
